(19) United States
(12) Patent Application Publication
(10) Pub. No.: US 2005/0041633 A1
(43) Pub. Date: Feb. 24, 2005

(54) Method for transferring information and associated network transition units

(75) Inventors: Wieland Roeser, Behrenhoff (DE); Frederick Wunderlich, Anklam (DE)

Correspondence Address: MORRISON & FOERSTER LLP, 1650 TYSONS BOULEVARD, SUITE 300, MCLEAN, VA, 22102, US

(73) Assignee: Siemens Aktiengesellschaft, Munchen (DE)

(21) Appl. No.: 10/473,969

(22) PCT Filed: Apr. 4, 2002
(86) PCT No.: PCT/EP02/03753

(30) Foreign Application Priority Data
Apr. 4, 2001 (EP) 01108481.1

(51) Int. Cl. H04L 12/28; H04J 3/04

(52) U.S. Cl. 370/351; 370/401; 370/535; 370/395.6

(57) ABSTRACT

Disclosed is a method wherein operative, administrative and maintenance functions are defined initially for a time-division multiplex oriented communication network (12). In order to utilize said functions in a packet-oriented communication network (10), they are emulated by said network (10).

### CLAIM FOR PRIORITY

This application claims priority to International Application No. PCT/EP02/03753, which was published in the German language on Oct. 17, 2002, which claims the benefit of priority to German Application No. 01108481.1 which was filed in the German language on Apr. 4, 2001.

### TECHNICAL FIELD OF THE INVENTION

The invention relates to a method for transferring information and associated network transition units, and in particular, a method for transferring information within at least one time-division multiplex oriented communication network via at least one packet-oriented communication network.

### BACKGROUND OF THE INVENTION

The time-division multiplex oriented communication network is, for example, an ISDN data transmission network (ISDN—Integrated Services Digital Network). In the time-division multiplex oriented communication network the data is transferred in different time slots in accordance with a time-division multiplex method.

The packet-oriented communication network is a network in which the information or data is transferred in data packets. The packet-oriented communication network is for example a communication network operating according to the Internet Protocol. Another example of a packet-oriented communication network is an ATM network (ATM—Asynchronous Transfer Mode), in which, however, the data packets are referred to as cells.

Functions for operation, administration and/or maintenance in the time-division multiplex oriented communication network have been defined for example in the following standards of the ETSI (European Telecommunications Standards Institute) or ITU-T

(International Telecommunication Union—Telecommunication Standardization Sector):

ETSI ETS 300 233, Integrated Services Digital Network (ISDN); Access Digital Section for ISDN Primary Rate, May 1994,
ITU-T G.962, Digital Sections and Digital Line Systems;
Access Digital Section for ISDN Primary Rate at 2048 kbit/s, March 1993,
ETSI ETS 300 011, Integrated Services Digital Network (ISDN); Primary Rate User-Network Interface Layer 1 Specification and Test Principles, April 1992.

Thus, the functions for operation, administration and/or maintenance relate for example to the activation of loopbacks or to error monitoring.

### SUMMARY OF THE INVENTION

The invention relates to a method for transferring information within at least one time-division multiplex oriented communication network via at least one packet-oriented communication network. Functions for operation and/or administration and/or maintenance are implemented in the time-division multiplex oriented communication network with the aim of transferring information within the time-division multiplex oriented communication network.

The information relates for example to user data or voice data.

The invention discloses, in one embodiment, a method for transmitting information within at least one time-division multiplex oriented communication network via at least one packet-oriented communication network, the method continuing to allow functions for operation, administration and/or maintenance of the time-division multiplex oriented communication network to be used in the time-division multiplex oriented communication network. Associated network transition units are also to be specified.

In another embodiment according to the invention, at least some of the information is transferred via the packet-oriented communication network. At the same time at least some of the functions for operation, administration and/or maintenance are emulated by the packet-oriented communication network. As a result the functions specified for the time-division multiplex oriented communication network can continue to be used essentially without restriction.

In another embodiment according to the invention, a customer-side network transition unit is interposed between a customer area and the packet-oriented communication network. The customer-side network transition unit is also referred to as a CP-IWF (Customer Premises—Interworking Function).

In the embodiment, an exchange-side network transition unit is additionally interposed between the packet-oriented communication network and an exchange of the time-division multiplex oriented communication network. The exchange-side network transition unit is also referred to as a CO-IWF (Central Office—Interworking Function).

In other embodiments according to the invention individual functions for operation, administration and maintenance are. In this case, the functions known from the time-division multiplex oriented communication network are retained in the time-division multiplex oriented communication network and emulated in the packet-oriented communication network.

In still another embodiment according to the invention, the emulation is provided by functions of the packet-oriented communication network, in particular by the customer-side network transition unit and by the exchange-side network transition unit.

In another embodiment, the packet-oriented communication network is an ATM network which is implemented according to the asynchronous transfer mode (ATM). By means of this embodiment powerful methods which have been defined in ATM standards, for example in the standards of the ATM Forum, can be used:
af-vtoa-0113.000, ATM Trunking Using AAL-2 for Narrowband Services, February 1999,
af-vmoa-0145.000, Voice and Multimedia over ATM—Loop Emulation Service Using AAL-2, July 2000.

In another embodiment, the packet-oriented communication network is implemented according to the ATM Adaption Layer 1 or according to the ATM Adaption Layer 2. These layers are also referred to as AAL1 and AAL2 respectively (AAL—ATM Adaption Layer). The AAL2 layer in particular is well suited to a reduction in bandwidth during the transmission in the packet-oriented communication network, in particular for the connection of subscribers. Reference is made for example to the standard af-vmoa-0145.000, Section 2.3, CP-IWF ATM Interfaces, 2.3.1 Physical Layer, where XDSL methods (XDSL—X-Digital Subscriber Line) are cited as examples of transmission methods, i.e. the ADSL method (ADSL—Asymmetrical Digital Subscriber Line) and the SDSL method (SDSL—Symmetrical Digital Subscriber Line).

In yet another embodiment the packet-oriented communication network is implemented according to the Internet Protocol. In this way, for example, the IP over ATM transmission method can be used.

In another embodiment, the time-division multiplex oriented communication network is an ISDN network. In connection with the invention the following standards relating to the ISDN network are particularly relevant:
ITU-T I.411, ISDN User Network Interfaces—Reference Configuration,
ITU-T I.412, ISDN User Network Interfaces—Interface Structures and Access Capabilities, and
ITU-T Q.512, Exchange Interfaces for Subscriber Access.

In another embodiment, parts of a primary multiplex access are replaced by the packet-oriented communication network. The primary multiplex access is also referred to as a Primary Rate Access. In one embodiment, the primary multiplex access is a so-called E1 access with a transmission capacity of 2,048 Mbit/s or a so-called DS1 access with a transmission capacity of 1,544 Mbit/s. The three above-mentioned standards relate to an E1 access. Integrating the packet-oriented communication network with the primary multiplex access allows the transmission bandwidth required on a subscriber access line to be considerably reduced. This enables transmission over two-wire copper lines, for example according to an XDSL method.

In one embodiment, furthermore, a multi time frame consisting of sixteen time frames, as described for example in ITU-T standard G.704, is used in the time-division multiplex oriented communication network. This time frame is explained in more detail below with reference to FIG. 2. The time frame includes in particular a so-called A bit for indicating alarm conditions, a so-called Sa5 bit, a so-called Sa6 bit and a so-called E bit for indicating error conditions. The bits are transferred in the start time slots TSO of each time frame.

In another embodiment, the start time slot TSO of each time frame is transferred over the packet-oriented communication network unchanged except for the mentioned changes in value, i.e. in particular without speech compression and without silence suppression.

Another embodiment relates to a customer-side network transition unit and to an exchange-side network transition unit, each of which contain function units during the operation of which the method steps related to the customer-side network transition unit and to the exchange-side network transition unit are performed according to the invention or one of its embodiments. Thus, the above-mentioned technical effects also apply to the two network transition units.

### BRIEF DESCRIPTION OF THE DRAWINGS

Exemplary embodiments of the invention are explained in the following with reference to the attached drawings, in which:

FIG. 1 shows an ISDN primary multiplex interface model with processing of a time slot TSO according to ETSI standard ETS 300 233.

FIG. 2 shows a CRC-4 multi time frame structure.

FIG. 3 shows function units and function sequences for activating a loopback in an exchange-side network transition unit CO-IWF.

FIG. 4 shows function units and function sequences for activating a loopback in a customer-side network transition unit CP-IWF.

FIG. 5 shows the monitoring of an ATM network by means of VCC (Virtual Channel Connection) performance monitoring (PMo—Performance Monitoring) and continuity monitoring (CC—Continuity Check) at an ATMdown interface of the customer-side network transition unit CP-IWF.

FIG. 6 shows the monitoring of the ATM network by means of VCC performance monitoring and continuity monitoring at an ATMup interface of the exchange-side network transition unit CO-IWF.

FIG. 7 shows function sequences when a CRC-4 error (Cyclic Redundancy Check) is reported by a customer telephony equipment TE.

FIG. 8 shows function sequences when a CRC-4 error is detected in a Tup signal of the customer-side network transition unit CP-IWF.

FIG. 9 shows function sequences when a CRC-4 error is reported by the customer equipment TE and simultaneously a CRC-4 error is detected in the Tup signal of the customer-side network transition unit CP-IWF.

FIG. 10 shows function sequences when a loss of signal (LOS—Loss of Signal) is detected or when a loss of frame alignment or frame synchronization (LFA—Loss of Frame Alignment) is detected at the Tup interface of the customer-side network transition unit CP-IWF.

FIG. 11 shows function sequences when an ATM connection error is detected at the ATMdown interface of the customer-side network transition unit CP-IWF.

FIG. 12 shows function sequences when an ATM connection error occurs at the ATMdown interface as a result of a loss of signal (LOS) at the exchange-side network transition unit CO-IWF.

FIG. 13 shows function sequences when a loss of signal (LOS) or loss of frame alignment (LFA) occurs at the T reference point of the customer-side network transition unit CP-IWF and simultaneously a loss of signal (LOS) occurs at the V3 reference point of the exchange-side network transition unit CO-IWF.

FIG. 14 shows function sequences when an ATM connection error occurs in the ATMup signal at the exchange-side network transition unit CO-IWF.

FIG. 15 shows function sequences when an AIS (Alarm Indication Signal) is detected at the customer-side network transition unit CP-IWF.

FIG. 16 shows function sequences when an AIS is detected in the ATMdown signal and simultaneously a loss of signal (LOS) or loss of frame alignment (LFA) occurs at the T reference point of the customer-side network transition unit CP-IWF.

FIG. 17 shows function sequences when an operating voltage failure is detected in the customer-side network transition unit CP-IWF.

FIG. 18 shows the reference model for the subscriber line (loop) emulation service using AAL2.

FIG. 19 shows a protocol reference model for a customer-side network transition unit CP-IWF with a user-side ISDN PRI and with DSS1 forwarding (DSS1—Digital Signaling System Number One) via the AAL2 between the network transition units IWF.

FIG. 20 shows a protocol reference model for an exchange-side network transition unit CO-IWF with user-side ISDN PRI and with DSS1 forwarding as well as with L3 (Layer 3) monitoring via the AAL2 between the network transition units IWF.

### DETAILED DESCRIPTION OF THE INVENTION

### Introduction to the Technical Environment

There are many reasons why support for an ISDN primary multiplex interface via the AAL2 (ATM Adaption Layer) using the principles and methods of the subscriber line emulation services (LES—Loop Emulation Services) according to the af-vmoa-0145.000 standard is desirable.

A concept for supporting an ISDN primary multiplex interface via AAL2/LES (ATM Adaption Layer 2/Loop Emulation Service) is disclosed in the following. Also, a text for supplementing the subscriber line emulation service (LES—Loop Emulation Service) using the AAL2 is proposed according to an exemplary embodiment based on the af-vxnoa-0145.000 standard, wherein the ISDN primary multiplex interface (PRI—Primary Rate Interface) is defined as a user-side interface. At the same time consistency with the support for the ISDN basic access interface (BRI—Basic Rate Interface) via AAL2 is ensured, as explained in the af-vmoa-0145.000 standard. The aim is to specify a solution that advantageously uses the powerful methods which have been defined for the subscriber line (loop) emulation service and which to date are not to be found in the approach for channel group transmission via AAL2 (AAL2 trunking). These powerful mechanisms include support for an embedded operation channel (EOC—Embedded Operation Channel), flexible assignment of a channel identifier (CID—AAL2 Channel Identifier) as well as channel activation using the ELCP protocol (ELCP—Emulated Loop Control Protocol).

### ISDN PRI Overview

An overview of the use of the ISDN primary multiplex interface in the world of classical time-division multiplex (TDM—Time Division Multiplex) is given below. Also specified are requirements which must be met if parts of the access digital section (DS—Digital Section) of the primary multiplex access are replaced by the ATM network. Furthermore, methods which meet these requirements are specified.

There are differences between the so-called DS1 (Digital Signal Level Number One) and E1 structures (E1—European Digital Signal Level Number One). The exemplary embodiments and explanations relate to the E1 structure. General statements applicable to both interfaces are however made wherever possible.

### ISDN Primary Multiplex Interface Model (PRI) with Operating and Maintenance Functions (for a 2048 kbps signal/E1)

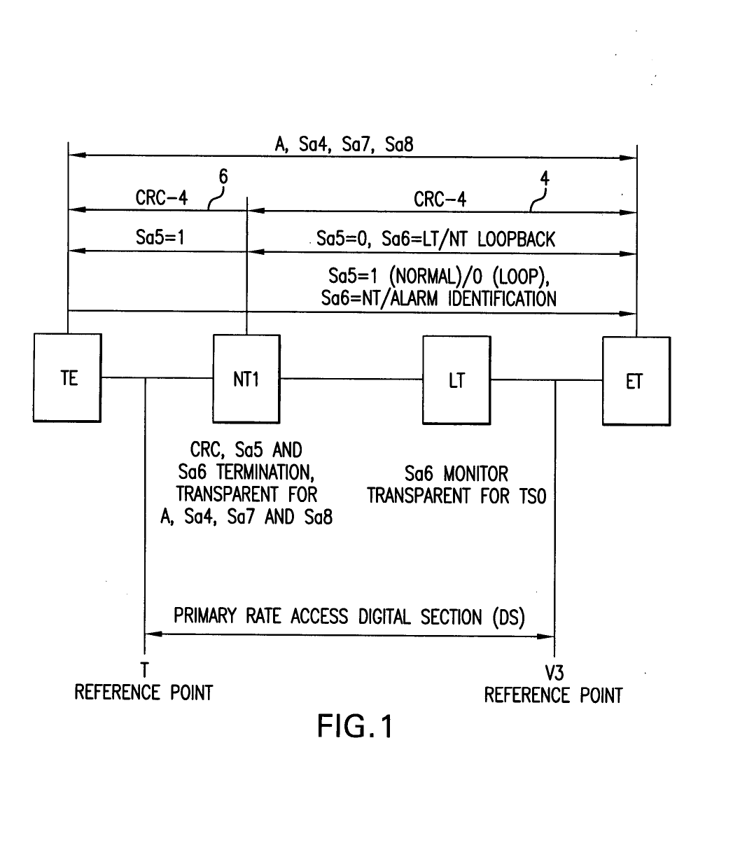

FIG. 1 shows an access digital section DS with its delimitations and the processing of time slot TS0.

The operating and maintenance functions support methods and information elements which are required for control of the access digital section by an exchange ET or a service node.

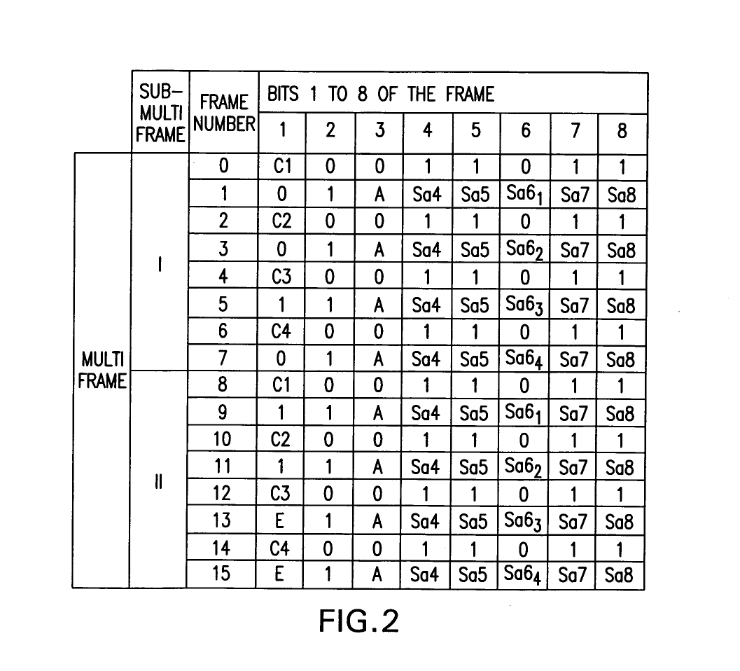

An Sa5, Sa6, E and A bit of a time slot TS0 are relevant for indication and control purposes. The bit structure of the time slot TS0 and the multi time frame structure are defined according to ITU-T standard G.704 and are explained in more detail below with reference to FIG. 2. The A bit is used for passing alarm status information between the service node and a customer telephony equipment TE (customer telephony end equipment). The A bit requires monitoring and is transferred transparently. Other control bits of the time slot TSO are to be transferred transparently. Also shown in FIG. 1 are the elements of the access digital section DS which use CRC methods 4, 6 (CRC—Cyclic Redundancy Check). The CRC-4 methods 4, 6 are implemented and used between the exchange ET and the network termination unit NT1 as well as between the network termination unit NT1 and the customer telephony equipment TE. This is also known as Option Two according to ITU-T standard G.962.

FIG. 1 also shows a line termination unit LT. Between the line termination unit LT and the exchange ET there is a V3 reference point. Between the customer telephony equipment TE and the network termination unit NT1 there is a T reference point.

The following table shows the signals which are exchanged between the T reference point and the access digital section DS during the normal operating conditions and error conditions specified in ETSI standard ETS 300 011:

| Name | List of signals |
|---|---|
| Normal operating mode | Operating time frame with: |
| time frame | active assigned CRC bits, |
| | CRC error information (cf. |
| | ITU-T standard G.704 for 2048 Kbit/s |
| | systems), |
| | no error indications |
| RAI (Remote Alarm Indication) | Operating time frame with: |
| | active assigned CRC bits, |
| | CRC error information (cf. |
| | ITU-T standard G.704 for 2048 Kbit/s |
| | systems), |
| | remote alarm indication (cf. |
| | ITU-T standard G.704, Table |
| | 4a, for 2048 Kbit/s systems, |
| | A bit is set to the value |
| | one) |
| LOS (Loss of Signal) | No input signal received (LOS) |
| AIS (Alarm Indication Signal) | Continuous bit stream of bits |
| | with the value one |
| CRC error information | E bit according to ITU-T |
| | standard G.704, Table 4b, set |
| | to the value zero if an errored |
| | CRC block is received (for a |
| | 2048 Kbit/s system only) |

The signals exchanged between the access digital section DS and the exchange ET are specified in the following table:

| Name | List of signals |
|---|---|
| Normal operating mode | Operating time frame with: |
| time frame | active assigned CRC bits, |
| | CRC error information (cf. |
| | ITU-T standard G.704 for 2048 Kbit/s |
| | systems), |
| | no error indicators |
| RAI (Remote Alarm Indication) | Operating time frame with: |
| | active assigned CRC bits, |
| | CRC error information (cf. |
| | ITU-T standard G.704 for 2048 Kbit/s |
| | systems), |
| | remote alarm indication (cf. |
| | ITU-T standard G.704, Table |
| | 4a, for 2048 Kbit/s systems, |
| | A bit is set to the value |
| | one) |
| LOS (Loss of Signal) | No input signal received (LOS) |
| AIS (Alarm Indication Signal) | Continuous bit stream of bits |
| | with the value one |
| CRC error information | E bit according to ITU-T |
| | standard G.704, Table 4b, set |
| | to the value zero if an errored |
| | CRC block is received (for a |
| | 2048 Kbit/s system only) |

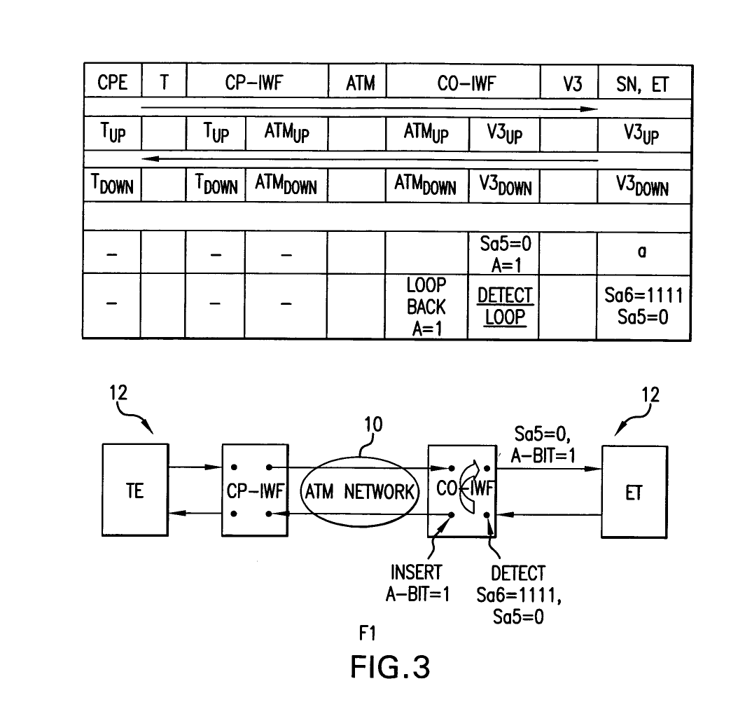

The following additional signals are required in order to indicate error conditions which occur in relation to the access digital section DS:

| Name | List of signals |
|---|---|
| Normal time frames | These are time frames without |
| | error indications or loopback |
| | requests generated by the |
| | exchange ET or the customer |
| | telephony equipment TE, where |
| | an A bit with the value one or |
| | zero is not relevant to the |
| | access digital section DS. |
| Time frames | These are time frames which, in |
| | addition to the normal time |
| | frames, have Sa6 bits |
| | containing error indication |
| | signals which have been |
| | generated in the network |
| | termination unit NT1 and |
| | transmitted to the exchange ET. |
| | Alternatively, the Sa6 bits may |
| | contain loopback requests which |
| | have been transmitted from the |
| | exchange ET to the access |
| | digital section DS. |
| | In this case the Sa5 bit is |
| | also used to indicate the |
| | direction and as a loopback |
| | indication. The Sa5 bit in the |
| | transmission direction from the |
| | access digital section DS to |
| | the exchange ET is set in the |
| | network termination unit NT1 or |
| | in the line termination unit LT |
| | and transmitted to the exchange |
| | ET according to the following |
| | rules: |
| | Sa5 = 1 Loopback 2 not |
| | activated, |
| | Sa5 = 0 Loopback 2 activated. |
| | The Sa6 bits are numbered |
| | Sa6(1), Sa6(2), Sa6(3), Sa6(4) |
| | and synchronized with the sub- |
| | multi time frames which are |
| | explained in more detail below |
| | with reference to FIG. 3. |
| Substitute time frame | In the event of a loss of |
| | signal (LOS) or loss of frame |
| | alignment (LFA) at the T |
| | reference point of the network |
| | termination unit NT1, a new |
| | time frame must be generated. |
| | The A bit is set to the value |
| | zero and the Sa4, Sa5, Sa7 and |
| | Sa8 bits as well as the bits of |
| | the time slots TS1 to TS31 are |
| | set to the value one. A bit |
| | sequence of Sa6 bits is used to |
| | indicate this error condition. |
| LFA | Loss of Frame Alignment |
| Operating voltage failure in | |
| the network termination unit | |
| NT1 or the line termination | |
| unit LT | |
| Auxiliary bit pattern | This is a time frame less and |
| (AUXP—Auxiliary Pattern) | continuous bit sequence of bits |
| | with alternating values of one |
| | and zero ( . . . 101010 . . . ) which |
| | is transmitted in both |
| | transmission directions by the |
| | line termination unit LT if a |
| | loss of signal (LOS) is |
| | detected at the corresponding |
| | receive unit |

FIG. 2 shows the structure of a CRC-4 multi time frame. The CRC-4 multi time frame consists of two sub-multi time frames I and II. Each sub-multi time frame I, II consists of eight time frames. The CRC-4 checksum is computed for all the bits of a sub-multi time frame I, II. The CRC bits C1, C2, C3 and C4 are transferred in bit one of the frame alignment signal.

The frame alignment signal is transmitted in even-numbered time frames (0, 2, 4, . . . ). The Sa bits, like the A bits (Remote Alarm Indication), are part of the signal not relating to the frame alignment. The Sa bits and the A bit are transmitted in the odd-numbered time frames (1, 3, 5, . . . ).

The first bit in each of the odd-numbered time frames 1, 3, 5, 7, 9 and 11 forms the CRC multi time frame alignment signal, which takes the form of a bit sequence with the value “001011”. Bit one in the thirteenth time frame is the so-called E bit and serves to indicate the reception of an errored sub-multi time frame by setting the E bit from the value one to the value zero for each errored sub-multi time frame I. The first bit in the fifteenth time frame serves to indicate an error for each errored sub-multi time frame II.

### CRC-4 Method

The CRC method serves to provide protection against errored frames (framing) and for error performance monitoring. This includes the multi time frame methods which are specified in ITU-T standard G.704.

If the access digital section DS is replaced by the ATM network 10 and the advantages of the AAL2 are used, it is not possible to perform or implement a CRC-4 method between the exchange ET and the network termination unit NT1.

For this reason ATM methods are used for this purpose in the exemplary embodiments, although these methods do not offer the same possibilities as CRC monitoring.

VCC (Virtual Channel Connection) performance monitoring (PMo—Performance Monitoring) and continuity monitoring (continuity check) are to be used in both transmission directions for monitoring between the network transition unit NT1 and the line termination unit LT. A new computation according to the CRC-4 error monitoring method is performed in the line termination unit LT in the transmission direction toward the exchange ET. No changes are necessary for the CRC-4 method between the network termination unit NT1 and the customer telephony equipment TE.

### Operation and Maintenance of the Access Digital Section

The methods described in the following permit the emulation of an operation and maintenance method for a primary multiplex interface (PRI OAM—Primary Rate Interface Operation Administration Maintenance) via an interface with the subscriber line (loop) emulation service (LES Interface—Loop Emulation Service Interface).

The access digital section DS provides the means for transmitting indicator elements and for detecting error conditions at the T reference point interface and the V3 reference point interface as well as for supporting test methods.

The following functions are supported according to ETSI standard ETS 300 233:
Loopbacks
   Loopback 1, transparent loopback in the line termination unit LT or in the exchange-side network transition unit CO-IWF (F1),
   Loopback 2, transparent loopback in the network termination unit NT1 or in the customer-side network transition unit CP-IWF (F2),
Error conditions
   within the access digital section DS
      loss of signal (LOS) or loss of frame alignment (LFA) on the line side of the network termination unit NT1 or the customer-side network transition function CP-IWF (in the the downstream signal; that is, the signal coming from the line termination unit LT or exchange-side network transition unit CO-IWF to the network termination unit NT1 or the customer-side network transition unit CP-IWF) (F9),
      loss of signal (LOS) on the line side of the line termination unit LT or the exchange-side network transition unit CO-IWF (F12),
      operating voltage failure in the network termination unit NT1 or in the customer-side network transition unit CP-IWF (F13),
      AIS (Alarm Indication Signal) on the line side of the network termination unit NT1 or the customer-side network transition unit CP-IWF, the AIS being generated in the network and forwarded transparently by the line termination unit LT or the exchange-side network transition unit CO-IWF (F13),
   at the V3 reference point
      loss of signal (LOS} (F10),
   at the T reference point
      loss of signal (LOS) or loss of frame alignment (LFA) (F8),
      operating voltage failure (if relevant) (F-)
Error performance monitoring
   errored CRC blocks detected on the line side of the network termination unit NT1 or the customer-side network transition unit CP-IWF (F3),
   errored CRC blocks detected at the T reference point of the network termination unit NT1 or the customer-side network transition unit CP-IWF (F6),
   CRC error indication received from the customer telephony equipment TE in the E bit (F5),
   errored CRC blocks detected at the T reference point of the network termination unit NT1 or the customer-side network transition unit CP-IWF and simultaneous reception of a CRC error information from the customer telephony equipment TE (F7).

The functions referred to are explained in more detail below with reference to exemplary embodiments. With regard to the above-mentioned functions, the reference specified in parentheses in each case indicates which emulated function F1 to F15 is used for the function concerned. The emulated functions F1 to F15 are explained in more detail below in this order with reference to FIGS. 3 to 17. The functions F4, F11 and F14 are not referred to in the above-mentioned list. The error condition on which the function F11 is based is an overlay composed of the error conditions on which functions F8 and F10 are based. The error condition on which function F14 is based is an overlay comprised of the error conditions on which functions F8 and F13 are based.

During a normal operating mode of the access digital section and in error conditions which permit the use of time frame signals, i.e. excluding loss of signal (LOS) or loss of frame alignment (LFA) at the T reference point of the network termination unit NT1 or the customer-side network transition unit CP-IWF, the information is transferred transparently in the time slots of the ISDN PRI signal via the access digital section D5. Similarly, the A, Sa4, Sa7 and Sa8 bits are also transferred transparently. The time frame and multi time frame alignment, the CRC-4 bits and the CRC error information (E bit) in both transmission directions as well as the Sa5 and Sa6 bits in the transmission direction toward the exchange ET are generated in the network termination unit NT1 or the customer-side network transition unit CP-IWF. In the case of a loss of signal (LOS) or a loss of time frame alignment (LFA) at the T reference point of the network termination unit NT1 or the customer-side network transition unit CP-IWF, a new time frame is generated. The A bit is set to the value zero. The Sa4, Sa5, Sa7 and Sa8 bits as well as the bits in the time slots TS1 to TS31 are set to the value one. These time frames are also known as substituted frames. A bit sequence consisting of Sa6 bits is used to indicate this error condition.

In the exemplary embodiment, instead of a full time-division multiplex frame (TDM Frame) being transferred via the ATM section, each time slot is mapped into a separate AAL2 channel. The time slots TS1 to TS31 contain user information and DSS1 signaling (DSS1—Digital Signaling System Number One). The time slot TS0 transfers error conditions or control information, e.g. loopback requests.

As mentioned already, some of the classical PRI-OAM methods (PRI-OAM—Primary Rate Interface-Operation Administration Maintenance) have to be emulated by means of ATM methods, whereby standardized methods defined in ITU-T standard I.610 are used. Thus, for example, the CRC-4 methods, the event indication and/or error indication in the access digital section DS and also the loopback methods are emulated by means of suitable ATM methods. The generation of the time frame and the generation of the multi time frame alignment signal are not possible in the network termination unit NT1 or the customer-side network transition unit CP-IWF in the transmission direction toward the exchange ET. The line termination unit LT or the exchange-side network transition unit CO-IWF handles these functions in the transmission direction toward the exchange ET. In the transmission direction toward the customer telephony equipment TE, the network termination unit NT1 or the customer-side network transition unit CP-IWF generates the time frame, the multi time frame alignment, the CRC-4 bits and the CRC error indication or error information.

### General Explanations Relating to FIGS. 3 to 18

In the upper part of each of the FIGS. 3 to 17 there is shown a table in the top row of which the columns of a table header are assigned in each case to the following elements in the order given below:
column 1 to the customer telephony equipment TE, which is also referred to as a CPE (Customer Premises Equipment),
column 2 to the T reference point,
columns 3 and 4 to the customer-side network transition unit CP-IWF,
column 5 to the ATM network 10,
columns 6 and 7 to the exchange-side network transition unit CO-IWF,
column 8 to the reference point V3, and
column 10 to the exchange ET, which is also referred to as a service node (Switching Node).

Rows 2 and 3 of the table header relate to the assignment of the columns in the transmission direction from the customer telephony equipment TE to the exchange ET. For this transmission direction:
column 1 relates to the data transmitted by the customer telephony equipment 12,
column 3 relates to the data received in the customer-side network transition unit CP-IWF from the side of the customer telephony equipment TE,
column 4 relates to the data transmitted by the customer-side network transition unit CP-IWF into the ATM network 10,
column 6 relates to the data received in the exchange-side network transition unit CO-IWF from the ATM network 10,
column 7 relates to the data transmitted by the exchange-side network transition unit CO-IWF to the exchange ET, and
column 9 relates to the data received in the exchange ET from the exchange-side network transition unit CO-IWF.

The positions mentioned are also referred to in this order as the Tup, Tup, ATMup, ATMup, V3up and V3up interface.

Rows 2 and 3 of the table header are in each case assigned to the first row of the table body.

Rows 4 and 5 of the table header relate to the transfer of data in the transmission direction from the exchange ET to the customer telephony equipment TE. For this transmission direction:
the first column of the table relates to the data received in the customer telephony equipment TE and originating from the customer-side network transition unit CP-IWF,
column 3 relates to the data transmitted by the customer-side network transition unit CP-IWF to the customer telephony equipment TE,
column 4 relates to the data received by the customer-side network transition unit CP-IWF from the ATM network 10,
column 6 relates to the data transmitted by the exchange-side network transition unit CO-IWF into the ATM network 10,
column 7 relates to the data received in the exchange-side network transition unit CO-IWF from the exchange ET, and
column 9 relates to the data transmitted by the exchange ET to the exchange-side network transition unit CO-IWF.

The positions mentioned for this transmission direction are also referred to in the given order as the Tdown, Tdown, ATMdown, ATMdown, V3down and V3down interface.

The second or last row of the table body is assigned to the transmission direction from the exchange ET to the customer telephony equipment TE.

The following symbols are used in the fields of the tables:
- no entry because none is necessary to an understanding of the exemplary embodiment or because in accordance with the known standard,
a analyze,
t transmit unchanged
underscore error/event detection point
x= . . . response to an error/event condition
### error/event cause

In addition to the entities already explained with reference to FIG. 1, FIGS. 3 to 17 also show a time-division multiplex data transmission network 12 on both sides of the ATM network 10.

### Loopbacks

Two different loopbacks are supported, a loopback in the exchange-side network transition unit CO-IWF and another loopback in the customer-side network transition unit CP-IWF.

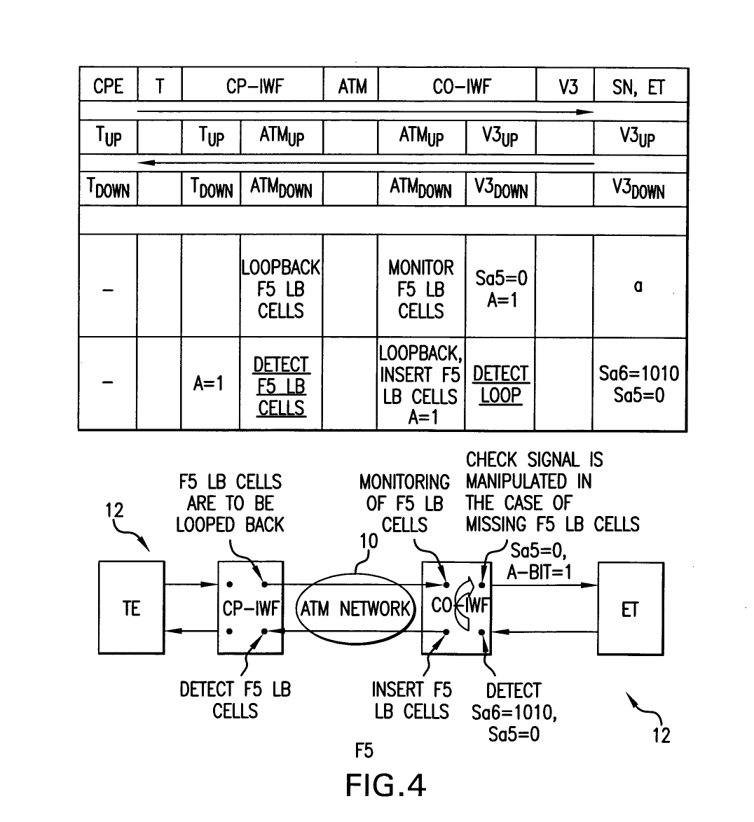

The loopbacks are activated as a result of special Sa bit sequences which are explained in more detail below with reference to FIGS. 3 and 4. A bit sequence with eight successive code words of the bits Sa6(1), Sa6(2), Sa6(3) and Sa6(4) forms a loopback command which must be detected before further measures are taken. Conversely, the loopback is released if eight successive commands for releasing the loopback or eight other successive signals have been received in which no loopback command has been detected.

FIG. 3 shows function units and function sequences for activating a loopback in the exchange-side network transition unit CO-IWF. In the case of the loopback in the exchange-side network transition unit CO-IWF, the exchange-side network transition unit CO-IWF transmits the ISDN PRI signal back to the exchange ET. In the transmission direction toward the customer-side network transition unit CP-IWF, the A bit is set to the value one. In the transmission direction toward the exchange ET, the A bit is set to the value one and the Sa5 bit is set to the value zero.

The function explained with reference to FIG. 3 is also referred to as function F1.

FIG. 4 shows function units and function sequences for activating a loopback in the customer-side network transition unit CP-IWF. The loopback in the customer-side network transition unit CP-IWF is produced as a result of the insertion of end-to-end F5 loopback cells which are also referred to as F5 LB (Loopback) cells. These cells are inserted by the exchange-side network transition unit CO-IWF after the loopback command relating to the network termination unit NT or the customer-side network transition unit CP-IWF has been detected. At the same time there is set up in the exchange-side network transition unit CO-IWF a local loopback which is similar to the loopback in the case explained with reference to FIG. 3 of a loopback in the line termination unit LT or the exchange-side network transition unit CO-IWF. The loopback is regarded as faulty if the LB cells do not return to their point of origin within five seconds. In this case the exchange-side network transition unit CO-IWF manipulates the loopback signal transmitted to the exchange ET. As a result the exchange ET can detect bit errors.

The function explained with reference to FIG. 4 is also referred to as function F2.

### Error Performance Monitoring

The CRC-4 monitoring is used to provide protection against incorrect time frames (framing) and for error performance monitoring of the access digital section DS. In order to enable service features such as free channel suppression, speech compression, voice activity detection and silence suppression, transparent transmission of the CRC-4 is not possible.

For this reason ATM monitoring methods such as VCC (Virtual Channel Connection) performance monitoring and VCC continuity monitoring are used simultaneously for the ATM section of the access digital section DS. The performance monitoring ensures real-time evaluation of the transmission quality for the selected VCCs at segment level or at end-to-end level. In the case of monitoring of the ATM section of the access digital section DS, the end-to-end VCC performance monitoring variant should be used. The performance monitoring is achieved by monitoring blocks from user cells. There are two applications of performance monitoring, namely forward monitoring and backward reporting together or forward monitoring on its own. In order to detect errored blocks of user cells it is sufficient to use only forward monitoring.

Performance monitoring is activated during the connection setup as part of the VCC method. In addition the activation or deactivation can be configured for each VCC with the aid of a telecommunication management network (TMN). For communication between the VCC end points, special OAM cells (OAM—Operation Administration Maintenance) are used, namely the FPM cells (FPM—Forward Performance Monitoring) and the BR cells (BR—Backward Reporting). The following parameters are obtained with the aid of performance monitoring:
a counter value for the number of transferred user information cells,
errored blocks,
a counter value for lost user information cells and a counter value for erroneously inserted user information cells within a monitored block consisting of cells.

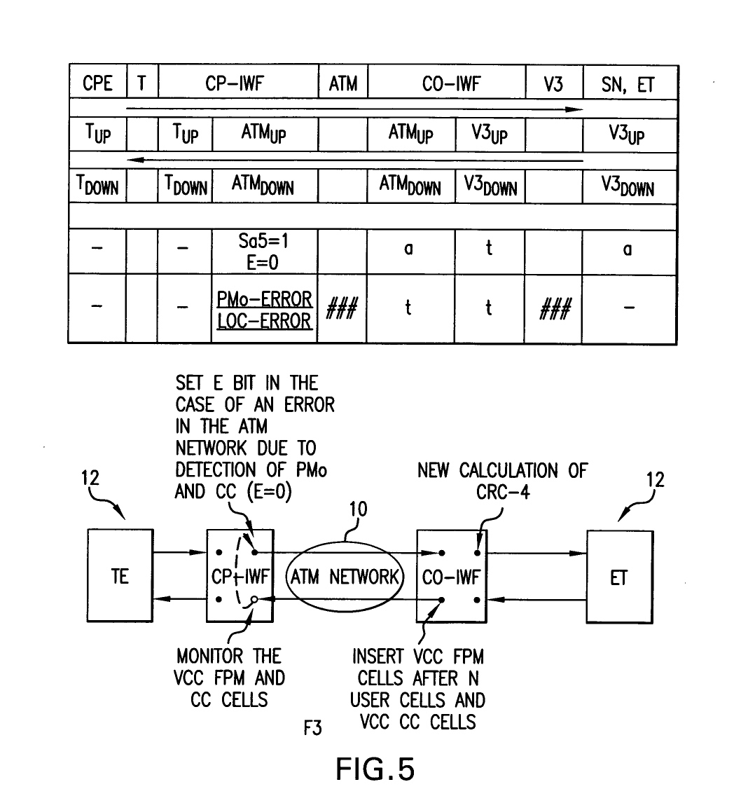

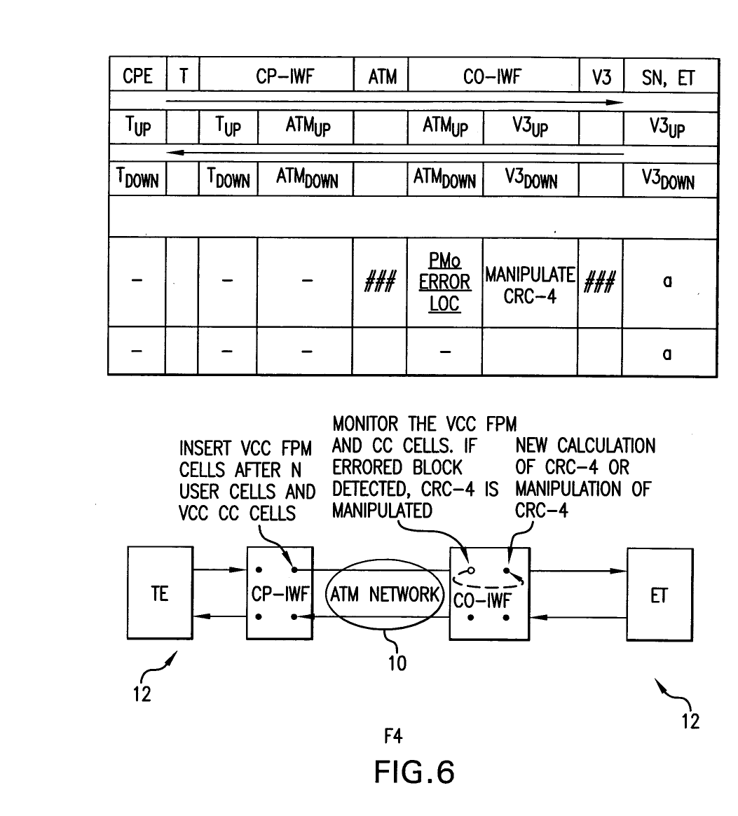

The CRC-4 checksum is computed afresh at the point of transition from the ATM network 10 to the time-division multiplex oriented network 12, i.e. in the transmission direction toward the exchange ET. If errors are detected as a result of VCC performance monitoring and continuity monitoring in the exchange-side network transition unit CO-IWF, this results in a CRC-4 error at the V3up interface of the exchange-side network transition unit CO-IWF (see explanatory remarks relating to FIG. 6 below). If a block error is detected by the exchange-side network transition unit CO-IWF, the E bit in the transmission direction toward the exchange ET is set to the value zero. This case is explained in FIG. 5.

FIG. 5 shows the monitoring of the ATM network 10 based on VCC performance monitoring and continuity monitoring at the ATMdown interface of the customer-side network transition unit CP-IWF. Performance errors or continuity errors on the access digital section DS detected on the line side by the customer-side network transition unit CP-IWF form a substitute for CRC-4 monitoring (error report). Error monitoring is simplified. The detection of bit errors in the access digital section DS is possible. There is no possibility of emulating other cases as specified in the ISDN PRI standard, e.g. for the case in which an additional Sa6 bit sequence is to be transmitted if a CRC-4 error threshold of 512 is exceeded.

FIG. 5 shows the case in which an errored block consisting of user cells has been detected on the basis of the received FPM cells or a loss of continuity (LOC—Loss of Continuity) has been detected as a result of VCC continuity monitoring.

FIG. 6 shows the monitoring of the ATM network 10 by means of VCC performance monitoring and by means of continuity monitoring at the ATMup interface of the exchange-side network transition unit CO-IWF. The figure shows the sequences when an error is detected in the ATM signal received by the exchange-side network transition unit CO-IWF.

VCC continuity monitoring is performed according to ITU-T standard I.610. Of the various functions specified in ITU-T standard I.610, the following are used:
continuity monitoring (CC—Continuity Check) is activated during the connection setup,
the VC CC cells are transmitted repeatedly at a periodicity of nominally one cell per second irrespective of the number of user cells transferred,
a loss of continuity (LOC) is detected if the VCC receiver (sink point) receives no user cell or no continuity monitoring cell wihtin a time interval of 3.5 seconds with a margin of 0.5 seconds.

VCC performance monitoring is likewise performed according to ITU-T standard I.610, the following options of ITU-T standard I.610 being used:
performance monitoring is activated during the connection establishment,
forward performance monitoring is supported,
the block size N, after which an FPM cell is inserted, lies outside the regulatory scope of the document, i.e. it is a configurable parameter.

The function explained with reference to FIG. 5 is also referred to as function F3. The function explained with reference to FIG. 6 is also referred to as function F4.

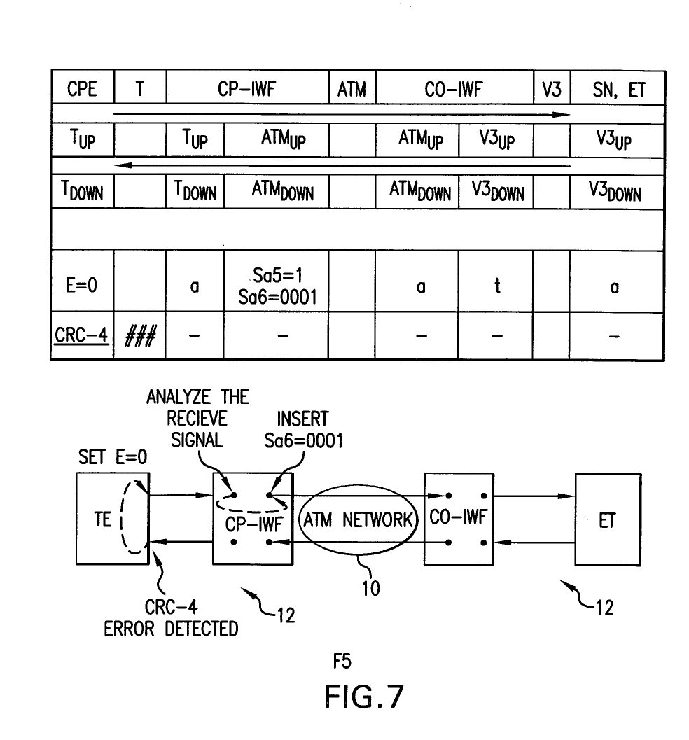

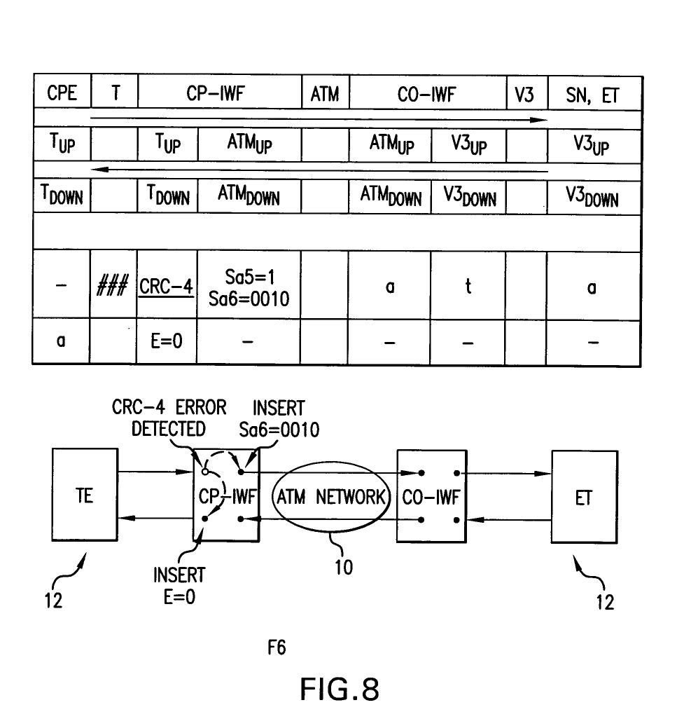

In addition, as shown in FIGS. 7 and 8, a second CRC-4 section is monitored between the customer-side network transition unit CP-IWF and the customer telephony equipment TE.

FIG. 7 shows the function sequences when a CRC-4 error is reported by the customer telephony equipment TE. The function explained in FIG. 7 is also referred to as function F5.

FIG. 8 shows function sequences when a CRC-4 error is detected in the Tup signal of the customer-side network transition unit CP-IWF. It is the task of the customer-side network transition unit CP-IWF to detect CRC-4 errors and indicate them to the exchange ET. The associated bit sequences are shown in the table in FIG. 8. The function shown with reference to FIG. 8 is also referred to as function F6.

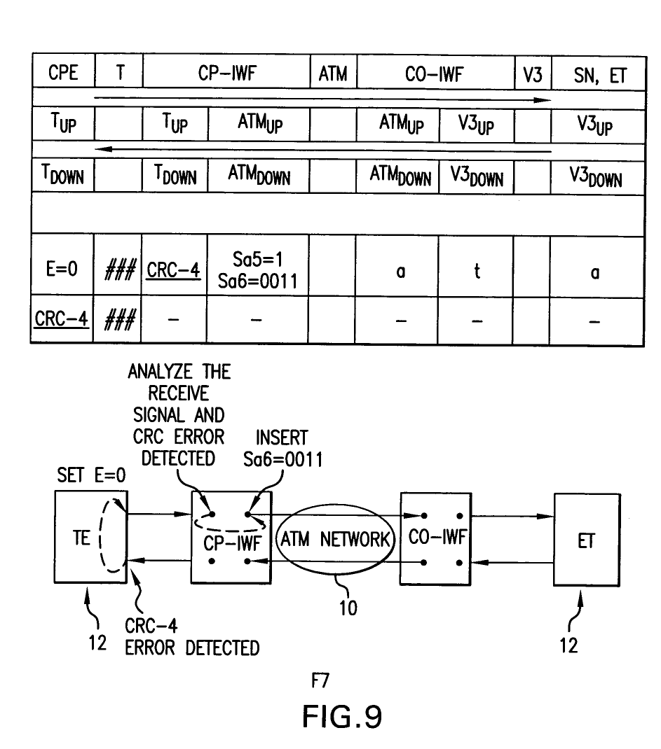

FIG. 9 shows function sequences when a CRC-4 error is reported by the customer telephony equipment TE and a CRC-4 error is simultaneously detected in the Tup signal of the customer-side network transition unit CP-IWF. The function shown with reference to FIG. 9 is also referred to as function F7. The error condition explained for function F7 is an overlay of the error conditions which have been explained in connection with functions F5 and F6 with reference to FIGS. 7 and 8.

### Error Indications

There follows an overview of the errors that occur and the associated error indications which have to be detected and transmitted in each case by the network transition unit.

These error indications are generated in the network termination unit NT1 or the customer-side network transition unit CP-IWF and transferred in the Sa6 bits to the exchange ET.

### LOS or LFA at the T Reference Point of the NT1/CP-IWF

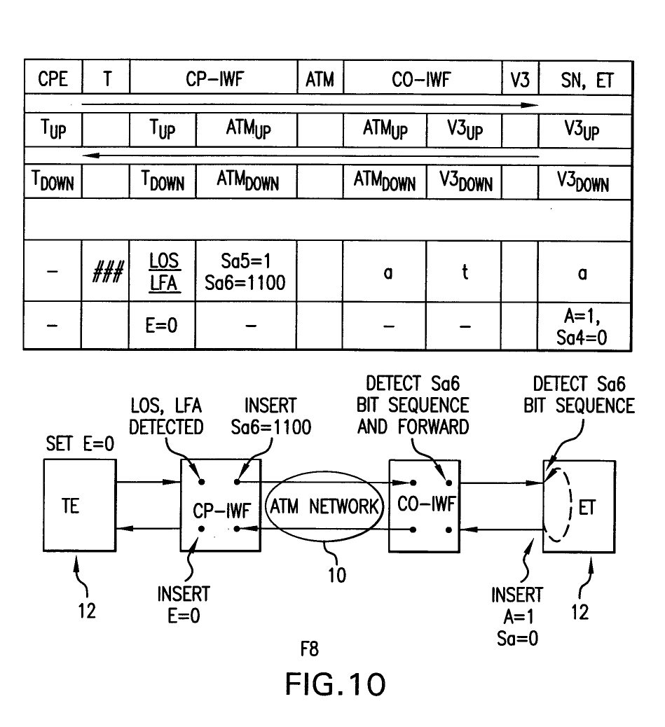

FIG. 10 shows function sequences when a loss of signal (LOS) or loss of frame alignment (LFA) is detected at the Tup interface of the customer-side network transition unit CP-IWF. When the loss of signal (LOS) or loss of frame alignment (LFA) is detected, the customer-side network transition unit CP-IWF transmits the Sa6 bit sequence with the value “1100” in the transmission direction toward the exchange-side network transition unit CO-IWF. The exchange-side network transition unit CO-IWF transmits the received Sa6 bit sequence unchanged, i.e. transparently, to the exchange ET. After receiving the Sa6 bit sequence, the exchange ET sets the A bit to the value one and the Sa4 bit to the value zero. These bits are inserted in time slot TS0 in the direction toward the customer. In addition the customer-side network transition unit CP-IWF inserts the E bit containing the value zero into the signal directed toward the customer telephony equipment TE or into the downstream signal.

The function explained with reference to FIG. 10 is also referred to as function F8.

### LOS or LFA on the Line Side of the NT1/CP-IWF

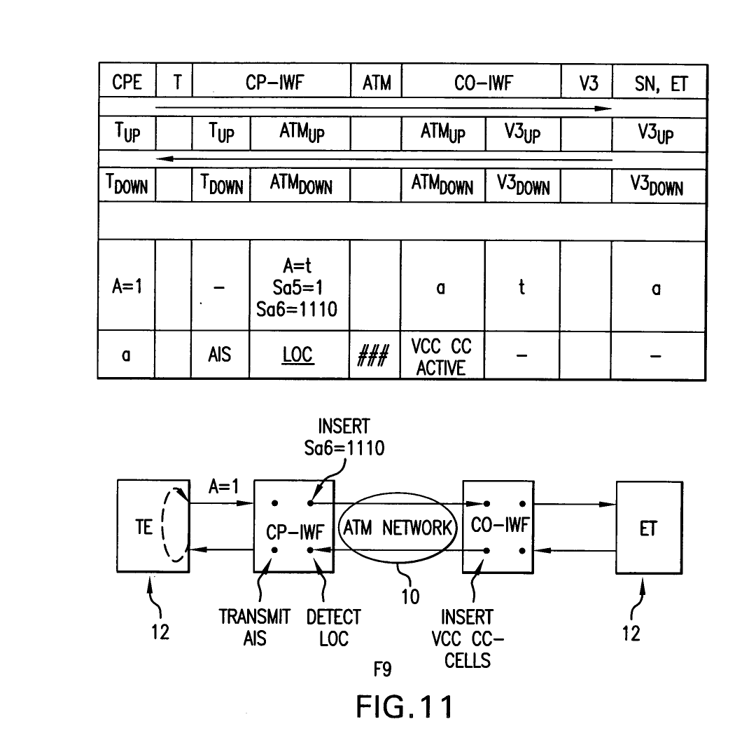

FIG. 11 shows function sequences when an ATM connection error is detected at the ATMdown interface of the customer-side network transition unit CP-IWF.

An error in the signal originating from the ATM network 10 is detected in the customer-side network transition unit CP-IWF as a result of end-to-end VCC continuity monitoring, loss of a cell, loss of cell alignment or cell synchronicity or due to a physical connection failure, in particular as a result of a loss of signal (LOS—Loss of Signal) at the XDSL level (XDSL—X-Digital Subscriber Line). The exchange-side network transition unit CO-IWF begins with VCC continuity monitoring (CC—Continuity Check) after the relevant VCC has been established. The VCC continuity monitoring is performed according to ITU standard I.610. Of the various options specified in the I.610 standard, the following are used:
continuity monitoring (CC) is activated during the connection establishment,
the VC CC cells are transmitted repeatedly at a periodicity of nominally one cell per second irrespective of the number of user cells transferred.

The function shown with reference to FIG. 11 is also referred to as function F9.

### LOS at the V3 Reference Point or at the Exchange-Side Network Transition Unit CO-IWF

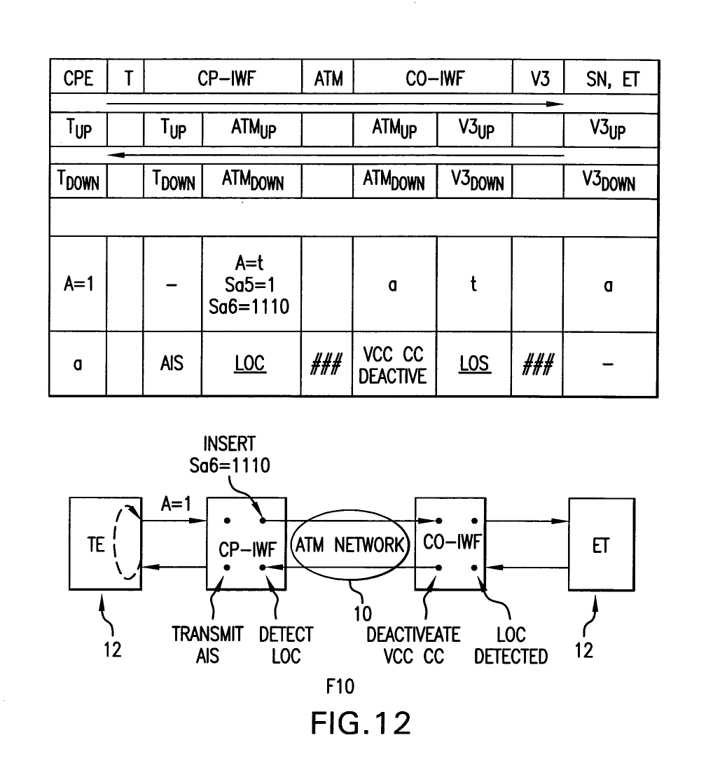

FIG. 12 shows function sequences when an ATM connection error occurs at the ATMdown interface, the error having been caused by a loss of signal (LOS) at the exchange-side network transition unit CO-IWF. The function sequences shown in FIG. 12 are similar to the function sequences explained with reference to FIG. 11. The exchange-side network transition unit CO-IWF deactivates the VCC continuity monitoring (CC) for as long as a loss of signal (LOS) is detected. In addition no user cells, including the cells for transferring the information of time slot TSO, are transmitted. In this way the customer-side network transition unit CP-IWF can detect an ATM connection error.

The function explained with reference to FIG. 12 is also referred to as function F10.

### LOS or LFA at the T Reference Point of the NT1/CP-IWF and LOS at the V3 Reference Point of the LT/CO-IWF

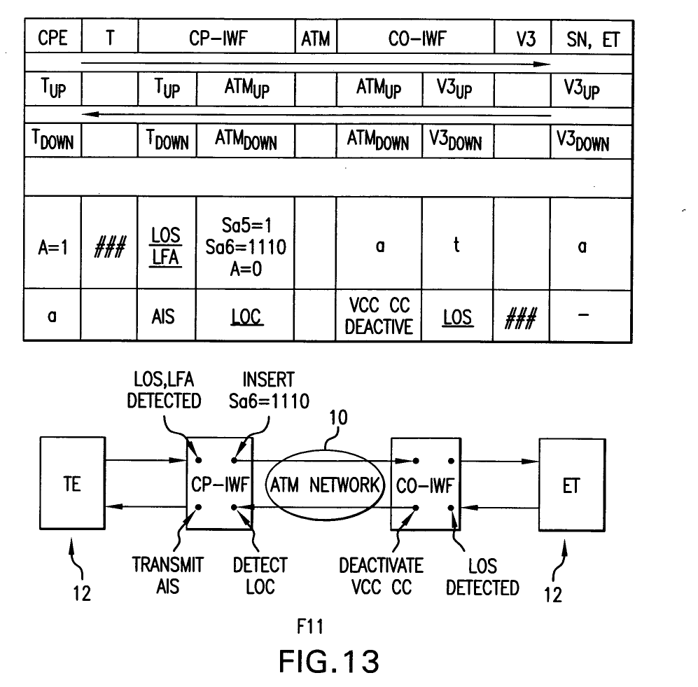

FIG. 13 shows function sequences when a loss of signal (LOS) or loss of frame alignment (LFA) occurs at the T reference point of the customer-side network transition unit CP-IWF and simultaneously a loss of signal (LOS) is detected at the V3 reference point of the exchange-side network transition unit CO-IWF. The function explained with reference to FIG. 13 is also referred to as function F11. The error condition explained for function F11 is a combination of the error conditions which have been explained above in connection with the functions F8 and F10 with reference to FIGS. 10 and 12 respectively.

### LOS on the Line Side of the LT/CO-IWF

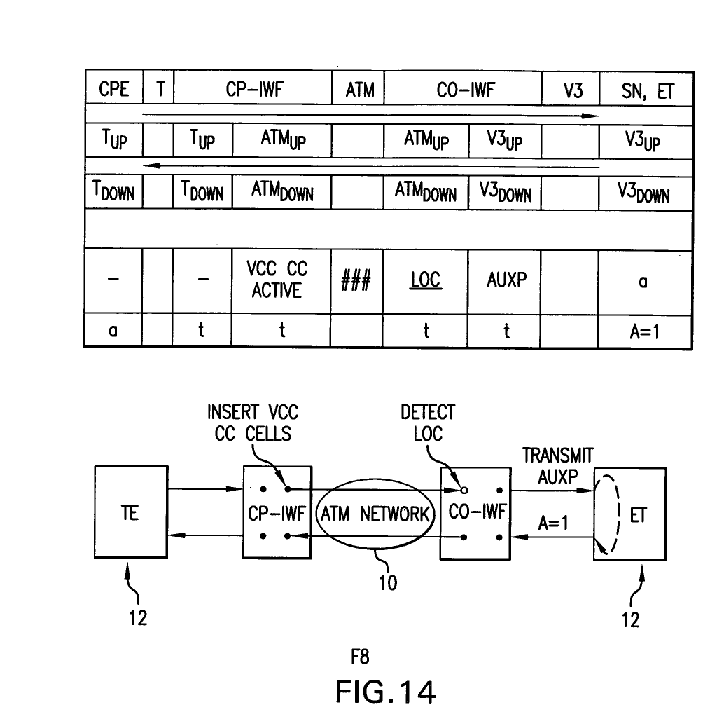

FIG. 14 shows function sequences when an ATM connection error occurs in the ATMup signal at the exchange-side network transition unit CO-IWF. If the exchange-side network transition unit CO-IWF detects an error in the ATMup signal as a result of the non-arrival of VCC continuity monitoring cells, loss of cells, loss of cell alignment or physical connection failure, e.g. due to a loss of signal (LOS) at XDSL level, the function sequences shown in FIG. 14, which are also referred to as function F12, are executed.

AIS at the V3 Reference Point of the CO-IWF and Transfer to the CP-IWF

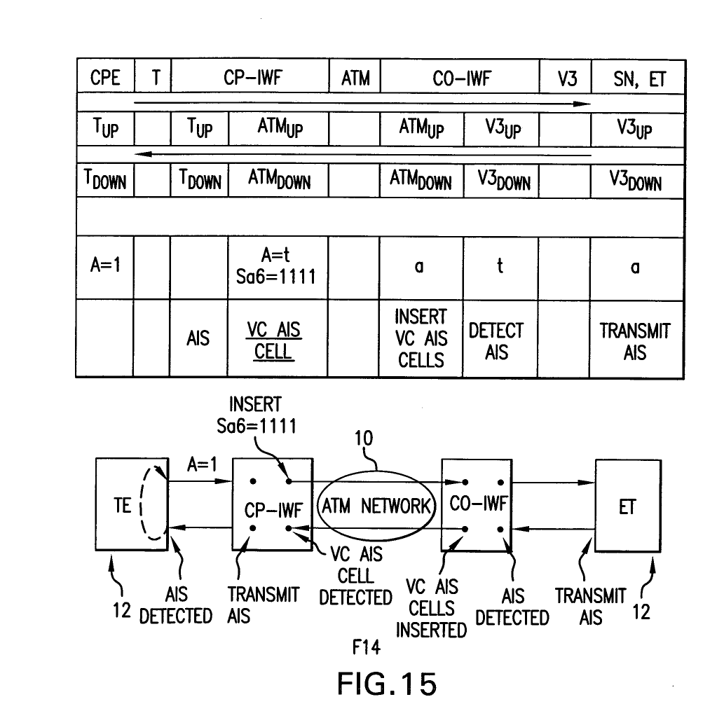

FIG. 15 shows function sequences when an AIS (Alarm Indication Signal) is detected at the customer-side network transition unit CP-IWF. The customer-side network transition unit CP-IWF detects the AIS on the line side. The AIS is generated in the time-division multiplex network 12 and forwarded by the exchange-side network transition unit CO-IWF. When AIS alarm data packets are received at the ATMdown interface of the customer-side network transition unit CP-IWF, the customer-side network transition unit CP-IWF transmits an AIS to the customer telephony equipment TE, which is also designated by the acronym CPE (Customer Premises Equipment). The customer telephony equipment TE returns an A bit with the value one, which is transferred unchanged, i.e. transparently, to the exchange ET. The cause for the AIS received in the customer-side network transition unit CP-IWF was an AIS bit sequence inserted by the exchange ET.

The function explained with reference to FIG. 15 is also referred to as function F13.

### LOS/LFA at the Tup Interface of the CP-IWF and AIS at the V3 Reference Point of the CO-IWF

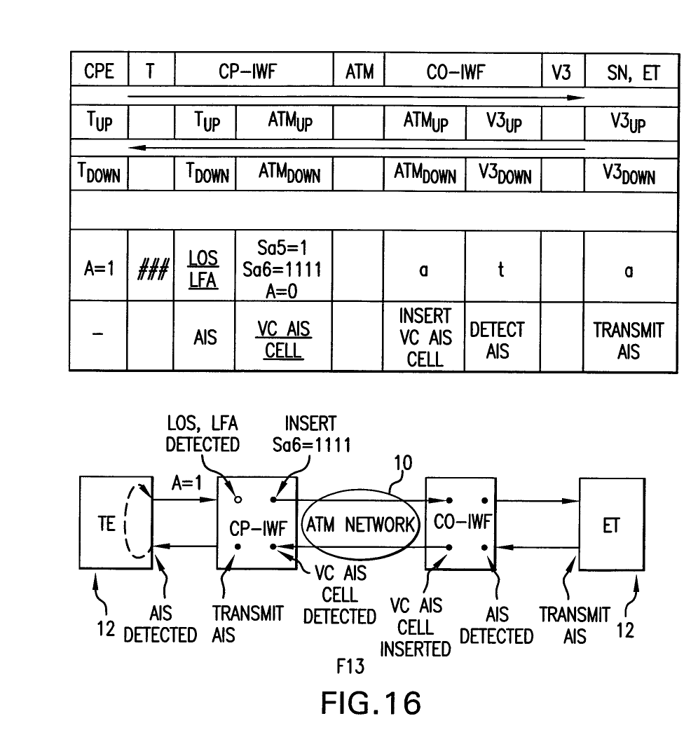

FIG. 16 shows function sequences when an AIS is detected in the ATMdown signal and simultaneously a loss of signal (LOS) or loss of frame alignment (LFA) is detected at the T reference point of the customer-side network transition unit CP-IWF. In this case, the AIS is transferred to the customer-side network transition unit CP-IWF. The function shown with reference to FIG. 16 is also referred to as function F14. Function 14 is based on an error case which is a combination of two error cases which have been explained above with reference to functions F8 and F13 and also with reference to FIGS. 10 and 15.

### Operating Voltage Failure in the NT1/CP-IWF

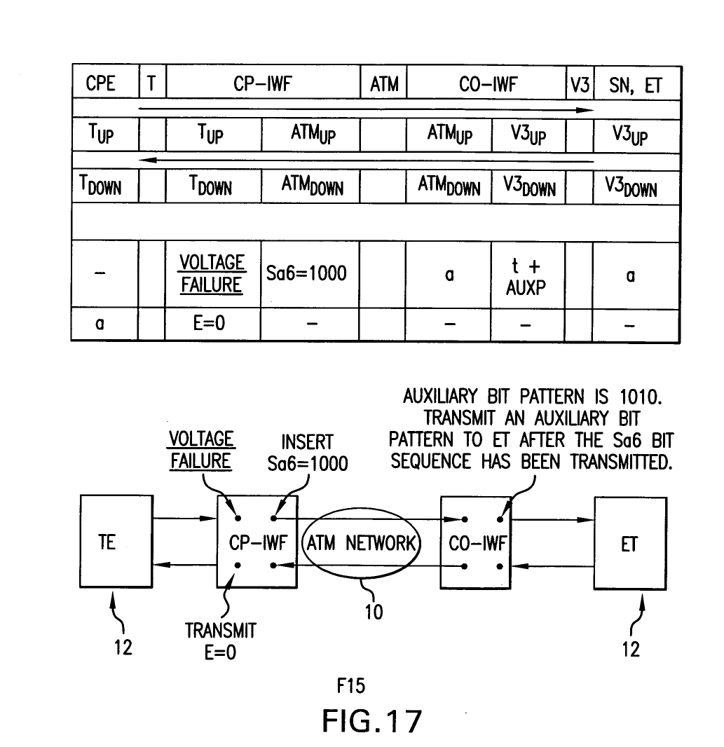

FIG. 17 shows function sequences when an operating voltage failure is detected at the customer-side network transition unit CP-IWF. When an operating voltage failure is detected by the customer-side network transition unit CP-IWF, the bit values shown in the table in FIG. 17 are used. The function shown in FIG. 17 is also referred to as function F15.

Exemplary Embodiment with Specification of the Basic Text for an ATM Standard

There follows an explanation of a further exemplary embodiment in which an expanded basic text is proposed for ATM standard af-vmoa-0145.000. Based on the exemplary embodiments already explained above, it is shown which text sections of the af-vmoa-0145.000 standard are to be replaced or supplemented. New sections are also specified.

Changes or addenda are indicated by a note at the beginning of each section, e.g. by “replaces section x.y.z of the af-vmoa-0145.000 standard”. Some sections must be added in the af-vmoa0145.000 standard because the aspects mentioned therein are not covered by the current basic document. This is indicated by a note, e.g. by “new section x.y.z required in af-vmoa-0145.000”. Subsections which contain no such comments are purely informative.

The text proposed in the exemplary embodiment still has to be revised for the purpose of drafting a basic text so as to bring it more closely into line with the structure of the af-vmoa-0145.000 standard.

Objectives

(Replaces Section 1.1 of the af-vmoa-0145.000 Standard)

The extension of the subscriber line loop emulation service using ARL2 for ISDN PRI services which are described in this document satisfies a need of the market for an efficient transfer method for carrying ISDN PRI traffic over a broadband subscriber line connection such as e.g. an XDSL line between a customer terminal equipment and the public circuit-switched or line-switched telephone network. The intention is to use the extension for access trunking to the public circuit-switched network with leased lines, as used mainly for the connection of PBXs (PBX—Private Branch Exchange).

The classical ISDN PRI is based on conventional time-division multiplex (TDM) methods with extended requirements and OAM principles (OAM—Operation Administration Maintenance) which have been specified for monitoring the circuit-switched connection. For this reason an ISDN PRI emulation service which uses the principles of the ATM/LES must also meet these requirements.

The methods required for this are specified in this document.

Scope

(Replaces Section 1.2 of the af-vmoa-0145.000 Standard)

This specification explains the methods which permit the efficient transfer of ISDN PRI (2048 kbps/E1 signal) services over an ATM network between two network transition units (IWF—Interworking Function). The network transition units are located:
in the customer area (CP-IWF with the user-side interface at the T reference point, specified in ITU-T standards I.411, I.431 and ETSI ETS 300 011), and
in the service provider area (CO-IWF with the local exchange interface at the V3 reference point, specified in ITU-T standard Q.512).

Also specified is the use of virtual ATM links via AAL2 for transporting bearer information and signaling. The virtual links used shall be PVCs (Permanent Virtual Circuit).

The regulatory scope of this specification covers:
the functionality of the network transition units IWF,
the relevant aspects of the control level for the subscriber line (loop) emulation service using AAL2 (Loop Emulation Service Using AAL2),
the relevant aspects of the user level for the subscriber line (loop) emulation service using AAL2,
relevant aspects of the network management level.
   Reference Model
   (Replaces Section 1.4 of the af-vmoa-0145.000 Standard)

This specification is intended to support the delivery of ISDN PRI services to customer premises via bandwidth-constrained ATM connections such as those provided for example by DSL (Digital Subscriber Line) systems.

In this reference model, only those entities are shown that pertain to the ISDN PRI services. In one implementation the equipment providing the CP-IWF function may also include data interfaces toward the customer, e.g. an Ethernet. The data traffic originating from such interfaces or terminating at such interfaces is carried over AAL5 or another appropriate AAL on the same ATM interface to the ATM network as the traffic in the voice band.

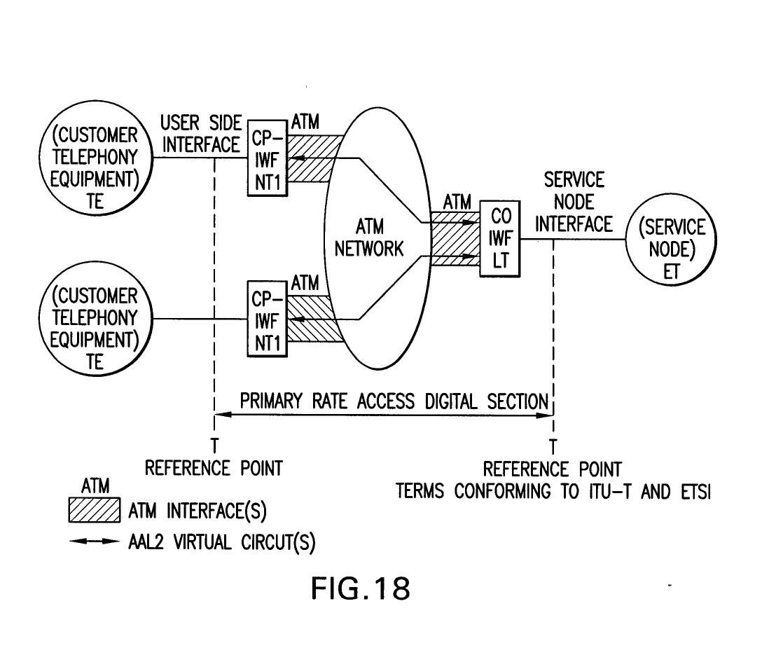

The service node shown in FIG. 18 stands for an exchange of the public circuit-switched telephone network (PSTN—Public Switched Telephone Network) which provides public telephone switching services and leased line services over a narrowband service node interface (SNI). The service node can connect the exchange-side network transition unit CO-IWF via one or more physical interfaces. Alternatively the CO-IWF functionality can be an integral part of the service node with the result that the physical interface between the exchange-side network transition unit CO-IWF and the service node is not visible toward the outside.

The physical connection between the CP-IWF and the ATM network is typically provided by a DSL (Digital Subscriber Line), an HFC (Hybrid Fibre Coax), a fiber optic link or a radio link. The ATM network may be a full network, a single ATM switching element or simply a direct interconnection between a CO-IWF and a CP-IWF.

The ATM virtual circuits through the ATM network between the CP-IWF and the CO-IWF shall be PVCs or SPVCs (Soft Permanent Virtual Circuits) which carry the following traffic:
bearer traffic and signaling using AAL2, where the DSS1 (Digital Signaling System Number One) for controlling the narrowband services is carried in an AAL2 channel within the same ATM VCC as the associated bearer traffic.

The CO-IWF and CP-IWF described in this specification are functional units which may be implemented as standalone devices, as parts of larger devices, or distributed among several different devices. This specification does not dictate the implementation of any one of these configurations.

CO-IWF Functionality

(In Addition to Section 1.7 of the af-vmoa-0145.000 Standard)

signaling adaptation (Signaling Interworking) for the transfer of fault messages (failures) and alarm messages (alarms) in order to receive maintenance signaling from the SNI (Service Node Interface) (if present) and from the ATM broadband interfaces and to insert signaling into the SNI and the ATM broadband interfaces. For example, a loopback command originating from the exchange ET is replaced by a VCC loopback and in the other transmission direction errors received in the AAL2 maintenance channel are mapped to error messages (notifications) via Sa bits into the signal which is not used for frame alignment.
   CP-IWF Functionality
   (In Addition to Section 1.8 of the af-vmoa-0145.000 Standard)
signaling adaptation (Signaling Interworking) for the transfer of failures and alarms in order to receive maintenance signaling from the ISDN PRI interfaces or from the ATM broadband interfaces and to insert signaling into the ISDN PRI interfaces or the ATM broadband interfaces. For example, alarm indications are transferred in the AAL2 maintenance channel.
   Interfaces Supported
   (Replaces Section 2 of the af-vmoa-0145.000 Standard)

This specification identifies the narrowband interfaces and specifies the ATM interfaces at the CP-IWF and the CO-IWF.

The IWFs may also provide other interfaces for management and administration purposes, but these are not specified in this document.

IWF Narrowband Interfaces

Physical Layer

On the physical layer, an IWF (CP- and CO-) should support DS1 or E1 circuits according to the ITU-T standards G.703 and G.704 depending on the application.

The channel structure of the primary multiplex interface (Primary Rate Interface Channel Structure) specified in ITU-T standard I.412 should be supported.

This means:
the primary multiplex B channel structure is supported, i.e. independent B channels operating at 64 kbps. For the E1 interface operating at 2,048 Mbps, the following applies: 30 B+D. For the DS1 interface operating at 1,544 Mbps, the following applies: 23 B+D.
The H channel structures are not supported (H0: 384 kbps (kilobits per second), H11: 1536 kbps, H12: 1920 kbps).
   IWF User-Side and Network-Side Interfaces

A CP-IWF must support suitable interfaces for ISDN PRI connection to a telephony equipment in the customer area. The specifications for this interface include:
a primary multiplex ISDN interface according to the ITU-T I.431 and ETSI ETS 300 011 standards or equivalent national specifications.

A CO-IWF must support appropriate interfaces for ISDN PRI connections to the telephone network (in compliance with ITU-T standard Q.512).

Signaling

On the signaling layer, an IWF shall support one of the following signaling systems depending on the required application:

Signaling systems with common channel:
N-ISDN signaling according to ITU-T standards Q.921 and Q.931 (DSS1).
N-ISDN according to the ETSI version of DSS1, as specified in the ETSI standards ETS 300 125 and ETS ETSI 300 102-1.
   Capabilities Supported
   ATM VCCs for Carrying AAL2 Channels for Supporting a PRI Via an LES (Replaces Section 3.2 of the af-vmoa-0145.000 Standard)

An ATM VCC between a CP-IWF and a CO-IWF may include traffic from precisely one ISDN primary multiplex interface.

DSS1 signaling for ISDN PRI lines and the B channels of the narrowband interface are carried in the same ATM VCC in different AAL2 channels. Time slot TS0 of an ISDN PRI shall be mapped into the AAL2 channel with the channel identifier CID=16.

Time slot TS0 contains the frame alignment signal or the signal not relating to the frame alignment which is used for transferring the maintenance and alarm information.

Signaling Between CO-IWF and CP-IWF for the ISDN PRI (Replaces Section 3.3.2 of the af-vmoa-0145.000 Standard)

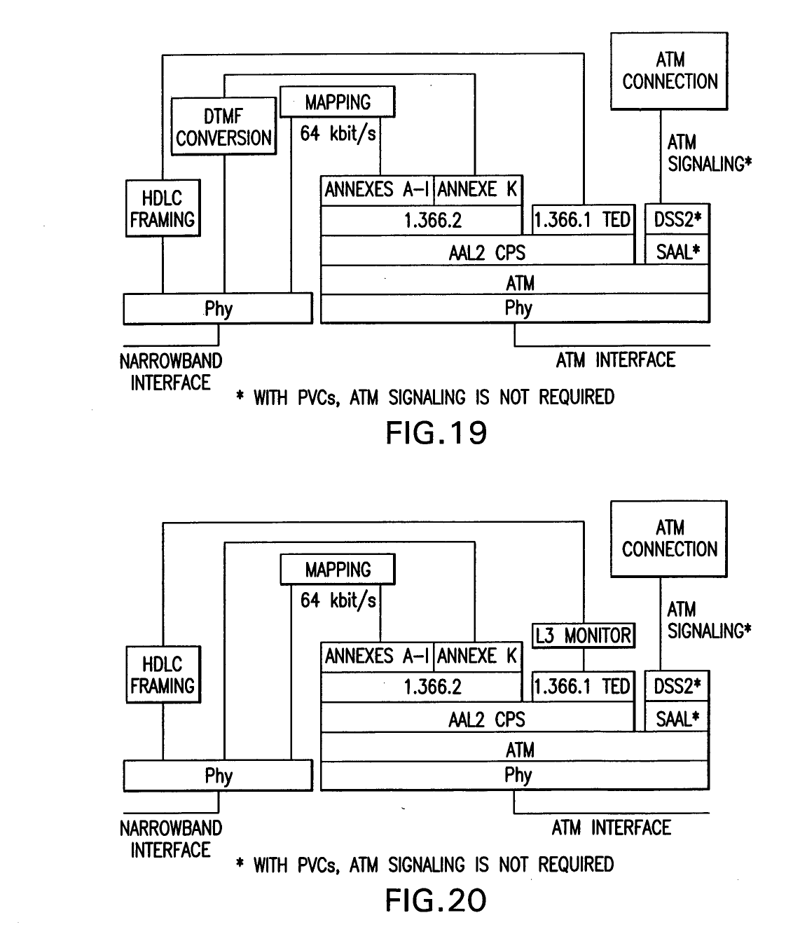

The protocol reference model for a CP-IWF with ISDN PRI in the direction toward the user-side interface is illustrated in FIG. 19. The transport of media streams between CP-IWF and CO-IWF is the same as in the case of analog telephony, including the optional use of tone dialing (DTMF Dial Digit Service—Dual Tone Multiple Frequency). The DSS1 signaling is not terminated in the CP-IWF. DSS1 signaling messages are relayed by the CP-IWF from the narrowband D channel across the AAL2 VCC using the transmission/error detection service as specified in ITU-T standard I.366.1.

Selection and Changing of Coding

(The First Part of this Section is Informative)

The same methods are valid as specified in the af-vmoa-0145.000 standard because the support for the H channel structures specified in ITU-T standard I.412 is not provided. These channel structures require time frame integrity. For this reason, AAL2 methods such as silence suppression and speech compression can only be used simultaneously for the entire H channel. Thus, for example, a change of coding profile within a profile would only be possible if it simultaneously affects all bearer channels. This means that in the case of an H0, H11 or H12 channel the profile change must take place for all 6, 23 or 30 B channels simultaneously.

(The Following Text Supplements Section 3.4.2 of the af-vmoa-0145.000 Standard)

Time slot TS0 of the ISDN PRI is mapped into the AAL2 channel with the CID=16. The SSCS (Service Specific Convergence Sublayer) specified in ITU-T standard I.366.2 is used in this channel with PCM64 coding and a change of coding profile is not permitted because the information contained in time slot TS0 must be transferred transparently. Consequently no speech compression and no silence suppression should be used for this channel.

Application Identifier (AppId)

(Supplements Section 4.1.1 of the af-vmoa-0145.000 Standard)

In addition an application identifier must be specified for:
the subscriber line (loop) emulation service using DSS1 to support PRI with ELCP (Emulated Loop Control Protocol).
   SSCS Type

The SSCS type to be used on each channel of an AAL2 VCC will vary according to the usage of that channel. Channels that are used to carry media streams (ISDN B channels) shall use the SCCS specified in ITU-T standard I.366.2. The channels that are used to carry the control and management level traffic (ELCP, DSS1 in the ISDN D channels and LES-EOC) shall use the SCCS specified in ITU-T standard I.366.1.

The SCCS specified in ITU-T standard ITU-T I.366.2 shall be used to carry additional failure and alarm messages such as are included in time slot TS0 of the ISDN PRI application, but without speech compression and/or silence suppression and VAD methods (Voice Activity Detection).

CID Allocation

(Supplements Section 4.4.1 of the af-vmoa-0145.000 Standard)

In the case of support for ISDN PRI the CID with the value sixteen shall be used for transferring time slot TS0 of the ISDN PRI signal. This CID is assigned during system startup, with the channel being activated at the same time.

Signaling and Control Methods

The information contained in this section must be assigned to the corresponding sections of the basic text in order to fit into the structure of the af-vmoa-0145.000 standard.

Additional signaling and control methods for ISDN PRI are disclosed.

Signaling Methods for the ISDN PRI

The ISDN PRI consists of:
30 time slots, numbered from 1 to 15 and 17 to 31, for transferring the B channels,
a signaling time slot with the number 16 for transporting the DSS1 signaling, and
a time slot with the number 0 for transferring the time frame alignment of the signal for the CRC multi time frame alignment, the CRC, and maintenance information in the case of an E1 interface.

Each active B channel, the signaling channel (DSS1 signaling), the ELCP protocol and the channel containing the frame alignment signal or the signal not relating to the frame alignment shall be transferred in a separate AAL2 channel of the same VCC. B channels are allocated dynamically to the AAL2 channels using the ELCP according to the call status. The AAL2 channels for the ELCP and the frame alignment signal and for the signal not relating to the frame alignment are allocated statically.

For DSS1 signaling, the AAL2 channel is allocated dynamically by the CO-IWF using an ALLOCATION message, as in the case of the ISDN BRI.

For the signal relating to the frame alignment and for the signal not relating to the frame alignment (TS0), the AAL2 channel is identified by the CID with the value sixteen.

Detection of Unused Channels (Idle Channel Detection)

The CO-IWF receives no explicit indication of the seizure or release of a channel, as in the case of the LES and a V5 or a GR303 SNI. The CO-IWF must therefore be informed by means of other measures.

The proposed solution is that the CO-IWF detects the call status “Idle” as a result of the monitoring of the DSS1 messages in time slot sixteen of the narrowband interface.

Based on the messages for call setup and release, the CO-IWF will seize or release the necessary ARL2 channels using ELCP.

The signaling information itself is transferred transparently between the IWFs using the SSSAR (Service Specific Segmentation And Reassembly) and the SSTED methods (Service Specific Transmission Error Detection) in accordance with the af-vmoa-0145.000 standard.

FIG. 20 shows the protocol reference model for the CO-IWF.

ISDN PRI Specific OAM Methods and Tables of the Alarm States

(A New Section is Required in the af-vmoa-0145.000 Standard)

Loopbacks

(The text contained in the Loopbacks section above should be inserted here, i.e. including the explanations concerning the functions F1 and F2 as well as FIGS. 3 and 4).

Error Monitoring

(The text contained in the Error monitoring section above should be inserted here, i.e. including the explanations concerning the functions F3 to F7 as well as FIGS. 5 to 9).

Error Indication

(The text contained in the Error indications section above should be inserted here, i.e. including the explanations concerning the functions F8 to F15 and FIGS. 10 to 17).

List of Reference Characters

DS Access digital section
4, 6 CRC-4 methods
TE, CPE Customer telephony equipment, Customer Premises Equipment
NT1 Network termination unit
LT Line termination unit
ET, SN Exchange, Service Node
CRC-4 Error code
A A bit
E E bit
Sa4 to Sa8 Sa4 to Sa8 bit
CP-IWF Customer-side network transition unit (Customer Premises Interworking Function
CO-IWF Exchange-side network transition unit (Central Office Interworking Function
10 ATM network
12 Time-division multiplex network
LOS Loss of Signal
LFA Loss of Frame Alignment)
LOC Loss of Continuity
CC Continuity Check)
AIS Alarm Indication Signal
TS0 Clock start time slot
a analyze
t forward transparently
FPM Forward Performance Monitoring
ATM Asynchronous Transfer Mode
F1 to F15 Function
V3, T Reference point
I, II Sub-multi time frame
LB Loopback
DS1 Connection type (1,544 Mbit/s)
E1 Connection type (2,048 Mbit/s)
AIS Alarm Indication Signal
AUXP Auxiliary Pattern

1. A method for transferring information within at least one time-division multiplex oriented communication network via at least one packet-oriented communication network, comprising:
implementing functions for operation and/or administration and/or maintenance in the time-division multiplex oriented communication network for transfer of the information within the time-division multiplex oriented communication network;
transferring at least a part of the information via the packet-oriented communication network; and
emulating at least some of the functions for operation, administration and maintenance of the time-division multiplex oriented communication network by the packet-oriented communication network.

2. The method according to claim 1, wherein a customer-side network transition unit is disposed between a customer area and the packet-oriented communication network,
and an exchange-side network transition unit is disposed between the packet-oriented communication network and an exchange of the time-division multiplex oriented communication network.

3. The method according to claim 2, wherein a function relates to the activation of a loopback from the exchange via the exchange-side network transition unit back to the exchange,
the exchange sets at least one Sa5 bit to the value zero and using successive Sa6 bits transmits an Sa6 bit sequence with the value “1111” at least eight times,
the values of the Sa5 bits and the Sa6 bit sequence are detected in the exchange-side network transition unit,
when the value zero is detected for the Sa5 bit when the value “1111” is detected eight times in succession for the Sa6 bit sequence by the exchange-side network transition unit, the data arriving from the exchange is transmitted back essentially unchanged to the exchange, whereby at least one A bit with the value one and at least one Sa5 bit with the value zero are transmitted from the exchange-side network transition unit to the exchange,
and at least one A bit with the value one is transferred by the exchange-side network transition unit via the packet-oriented communication network.

4. The method according to claim 2, wherein one of the functions relates to activation of a loopback from the exchange, via the exchange-side network transition unit, via the customer-side network transition unit, back to the exchange-side network transition unit and then back to the exchange,
the exchange transmits at least one Sa5 bit with a value zero and an Sa6 bit sequence with a value “1010” at least eight times,
the value of the Sa5 bit and the value of the Sa6 bit sequence are detected in the exchange-side network transition unit,
when the value zero is detected for the Sa5 bit and when the value “1010” is detected eight times in succession for the Sa6 bit sequence by the exchange-side network transition unit, the data arriving from the exchange is transmitted back essentially unchanged to the exchange, whereby at least one A bit with a value one and at least one Sa5 bit with a value zero are transmitted by the exchange-side network transition unit to the exchange, and
whereby the incoming data is manipulated depending on transmission errors in a part of the loopback located in the packet-oriented communication network,
the transmission of loopback data packets is initiated by the exchange-side network transition unit,
the loopback data packets are detected in the customer-side network transition unit and transmitted back to the exchange-side network transition unit,
the exchange-side network transition unit checks the received loopback data packets and depending on the result of the check manipulates the data to be transmitted to the exchange, and upon detection of a loopback data packet at least one A bit with the value one is transmitted to a customer telephony equipment by the customer-side network transition unit.

5. The method according to claim 2, wherein one of the functions relates to the monitoring of the performance and continuity of the transmission from the exchange-side network transition unit to the customer-side network transition unit,
performance data packets and continuity data packets are generated in the exchange-side network transition unit and transmitted to the customer-side network transition unit,
the performance data packets and continuity data packets are monitored in the customer-side network transition unit,
when an error is detected by the customer-side network transition unit at least one E bit with a value zero is transmitted via the packet-oriented communication network to the exchange-side network transition unit and is forwarded to the exchange,
and in the exchange-side network transition unit a new checksum is computed for the data to be transmitted to the exchange.

6. The method according to claim 2, wherein on of the function relates to the monitoring of the performance and continuity of the transmission from the customer-side network transition unit to the exchange-side network transition unit,
performance data packets and continuity data packets are generated in the customer-side network transition unit and transmitted to the exchange-side network transition unit,
the performance data packets and continuity data packets are monitored in the exchange-side network transition unit,
upon an error the computation of a checksum for the data to be transmitted to the exchange is manipulated,
and in the error-free case a checksum for the data to be transmitted to the exchange is computed without manipulation.

7. The method according to claim 2, wherein one of the function relates to an error which is reported by a customer telephony equipment,
that the error monitoring method is performed in the customer telephony equipment,
when an error is detected by the customer telephony equipment least one E bit with a value zero is transmitted to the customer-side network transition unit,
the value of the E bit is monitored in the customer-side network transition unit,
when the value zero is detected for the E bit by the customer-side network transition unit at least one Sa5 bit with the value one and at least one Sa6 bit sequence with the value “0001” are transmitted via the packet-oriented communication network to the exchange-side network transition unit and are forwarded to the exchange.

8. The method according to claim 2, wherein one of the function relates to an error which is detected by the customer-side network transition unit,
the error monitoring method is performed in the customer-side network transition unit,
when an error is detected by the customer-side network transition unit at least one Sa5 bit with a value one and at least one Sa6 bit sequence with a value “0010” are transmitted via the packet-oriented communication network to the exchange-side network transition unit and are forwarded to the exchange,
and upon an error being detected by the customer-side network transition unit at least one E bit with the value zero is transmitted to the customer telephony equipment.

9. The method according to claim 2, wherein one of the function relates to a first error which is reported by a customer telephony equipment and to a second error which is detected by the customer-side network transition unit,
a first error monitoring method is performed in the customer telephony equipment,
upon an error being detected by the customer telephony equipment at least one E bit with a value zero is transmitted to the customer-side network transition unit,
the values of the E bits are monitored in the customer-side network transition unit,
a second error monitoring method is performed in the customer-side network transition unit,
and upon an error being detected by the second error monitoring method and when the value zero is detected for the E bit by the customer-side network transition unit at least one Sa5 bit with a value one and at least one Sa6 bit sequence with a value “0011” are transmitted via the packet-oriented communication network to the exchange-side network transition unit and are forwarded to the exchanges.

10. The method according to acclaim 2, wherein one of the function relates to the detection of a loss of signal or a loss of frame alignment between a customer telephony equipment and the customer-side network transition unit,
upon a loss being detected in the customer-side network transition unit at least one Sa5 bit with a value one and at least one Sa6 bit sequence with a value “1100” are transmitted by the customer-side network transition unit via the packet-oriented communication network to the exchange-side network transition unit and are forwarded to the exchange,
and when a loss is detected by the customer-side network transition unit at least one E bit with the value zero is transmitted to the customer telephony equipment.

11. The method according to claim 1, wherein one of the functions relates to detection of a loss of continuity or a loss of a cell or a loss of cell alignment or a physical connection failure in the packet-oriented communication network,
continuity data packets are generated in the exchange-side network transition unit and transmitted to the customer-side network transition unit,
the continuity data packets are detected in the customer-side network transition unit,
upon non-arrival of the continuity data packets or upon a loss of cell or a loss of cell alignment or a physical connection failure being detected by the customer-side network transition unit, a continuous bit sequence of bits with a value one is transmitted to a customer telephony equipment,
and upon non-arrival of the continuity data packets or upon a loss of cell or a loss of cell alignment or a physical connection failure being detected in the customer-side network transition unit A bits originating from the customer telephony equipment are transmitted unchanged via the packet-oriented communication network,
and upon non-arrival of the continuity data packets or upon a loss of cell or a loss of cell alignment or a physical connection failure being detected by the customer-side network transition unit at least one Sa5 bit with a value one and at least one Sa6 bit sequence with a value “1110” are transmitted via the packet-oriented communication network to the exchange-side network transition unit and are forwarded to the exchange.

12. The method according to acclaim 2, wherein one of the functions relates to detection of a loss of signal between the exchange and the exchange-side network transition unit,
upon a loss being detected in the exchange-side network transition unit by the exchange-side network transition unit no further continuity data packets are transmitted via the packet-oriented communication network,
the continuity data packets are monitored in the customer-side network transition unit,
upon non-arrival of the continuity data packets a continuous bit sequence of bits with a value one is transmitted by the customer-side network transition unit to a customer telephony equipment,
upon non-arrival of the continuity data packets in the customer-side network transition unit A bits originating from the customer telephony equipment are transmitted unchanged via the packet-oriented communication network,
and upon non-arrival of the continuity data packets from the customer-side network transition unit at least one Sa5 bit with a value one and at least one Sa6 bit sequence with a value “1110” are transmitted via the packet-oriented communication network to the exchange-side network transition unit and are forwarded to the exchange.

13. The method according to claim 1, wherein one of the functions relates to detection of a loss of signal or a loss of frame alignment between a customer telephony equipment and the customer-side network transition unit and to detection of a loss of signal between the exchange and the exchange-side network transition unit,
upon a loss of signal being detected between the exchange and the exchange-side network transition unit in the exchange-side network transition unit no further continuity data packets are transmitted via the packet-oriented communication network,
the continuity data packets are monitored in the customer-side network transition unit,
upon non-arrival of the continuity data packets a continuous bit sequence of bits with a value one is transmitted by the customer-side network transition unit to the customer telephony equipment,
upon non-arrival of the continuity data packets at least one Sa5 bit with a value one and at least one Sa6 bit sequence with a value “1110” are transmitted by the customer-side network transition unit via the packet-oriented communication network to the exchange-side network transition unit and from there are forwarded to the exchange,
and upon a loss of signal or a loss of frame alignment being detected between the customer telephony equipment and the customer-side network transition unit and simultaneous non-arrival of the continuity data packets at least one A bit with a value zero is transmitted by the customer-side network transition unit via the packet-oriented communication network to the exchange-side network transition unit and is forwarded to the exchange.

14. The method according to claim 2, wherein one of the function relates to detection of a loss of continuity or a loss of cell or a loss of cell alignment or a physical connection failure between the customer-side network transition unit and the exchange-side network transition unit,
continuity data packets are generated in the customer-side network transition unit and transmitted to the exchange-side network transition unit,
upon non-arrival of the continuity data packets or upon a loss of cell or a loss of cell alignment or a physical connection failure being detected by the exchange-side network transition unit a bit sequence conforming to a predefined auxiliary bit pattern is transmitted to the exchange,
and the exchange, after receiving the bit sequence, transmits an A bit with the value one to the exchange-side network transition unit.

15. The method according to acclaim 2, wherein one of the function relates to detection of a continuous bit sequence of bits with a value one,
an occurrence of the continuous bit sequence of bits with a value one originating from the exchange is monitored in the exchange-side network transition unit,
that when the bit sequence is detected at least one alarm data packet is generated and transmitted via the packet-oriented communication network to the customer-side network transition unit,
the occurrence of alarm data packets is detected in the customer-side network transition unit,
when an alarm data packet is detected by the customer-side network transition unit the continuous bit sequence of bits with a value one is transmitted to a customer telephony equipment,
when an alarm data packet is detected in the customer-side network transition unit A bits originating from the customer telephony equipment are transmitted unchanged via the packet-oriented communication network,
and when an alarm data packet is detected by the customer-side network transition unit at least one Sa6 bit sequence with a value “1111” is transmitted via the packet-oriented communication network to the exchange-side network transition unit and is forwarded to the exchange.

16. The method according to claim 2, wherein on of the functions relates to detection of a continuous bit stream of bits with a value one and to detection of a loss of signal or a loss of frame alignment between a customer telephony equipment and the customer-side network transition unit,
an occurrence of the continuous bit sequence of bits with a value one originating from the exchange is monitored in the exchange-side network transition unit,
when the bit sequence is detected at least one alarm data packet is generated and transmitted via the packet-oriented communication network to the customer-side network transition unit,
the occurrence of alarm data packets and the signal and the frame alignment between the customer telephony equipments and the customer-side network transition unit are monitored in the customer-side network transition unit,
when an alarm data packet tis detected by the customer-side network transition unit the continuous bit sequence of bits with a value one is transmitted to the customer telephony equipment,
when an alarm data packet and a loss of signal or a loss of frame alignment is detected, at least one A bit with a value zero is transmitted by the customer-side network transition unit via the packet-oriented data communication network to the exchange-side network transition unit and from there is forwarded to the exchanges,
and when an alarm data packet is detected by the customer-side network transition unit at least one Sa5 bit with a value one and at least one Sa6 bit sequence with a value “1111” are transmitted via the packet-oriented communication network to the exchange-side network transition unit and are forwarded to the exchange.

17. The method according to claim 2, wherein one of the functions relates to detection of a voltage failure in the customer-side network transition unit,
the operating voltage is monitored in the customer-side network transition unit,
upon failure of the operating voltage in the customer-side network transition unit at least one Sa6 bit sequence with a value “1000” is transmitted via the packet-oriented communication network to the exchange-side network transition unit and is forwarded to the exchange,
upon failure of the operating voltage in the customer-side network transition unit at least one E bit with a value zero is transmitted to a customer telephony equipment,
and the exchange-side network transition unit transmits the Sa6 bit sequence unchanged and subsequently a bit sequence conforming to a predefined auxiliary bit pattern to the exchange.

18. The method according to claim 2, wherein the emulation is implemented by functions of the packet-oriented communication network.

19. The method according to claim 2, wherein the packet-oriented communication network is implemented according to asynchronous transfer mode.

20. The method according to claim 2, wherein the packet-oriented communication network is implemented according to the asynchronous transfer mode Adaption Layer 1 or according to the asynchronous transfer mode Adaption Layer 2.

21. The method according to claim 2, wherein the packet-oriented communication network is implemented according to the Internet Protocol.

22. The method according to claim 2, wherein the time-division multiplex oriented communication network is an ISDN network.

23. The method according to claim 22, wherein part of a primary multiplex access is replaced by the packet-oriented communication network,
and/or the primary multiplex access includes an XDSL line between the customer-side network transition unit and the packet-oriented communication network.

24. The method according to claim 2, wherein operation, administration and maintenance functions are provided essentially according to ETSI standard ETS 300 011 and/or according to ITU-T standard G.962 and/or according to ETSI standard ETS 300 233.

25. The method according to claim 2, wherein a multi time frame including sixteen time frames according to ITU-T standard G.704 is used in the time-division multiplex oriented communication network, the multi time frame including an A bit in a third position and/or an Sa5 bit in a fifth position and/or an Sa6 bit in a sixth position in a start time slot of every second time frame beginning with the second start time slot of the multi time frame,
and/or including an E bit in the first position of the second-to-last time frame and/or the last time frame of a multi time frame.

26. The method according to claim 25, wherein the data of the start time slot of each time frame is transmitted unchanged in value via the packet-oriented communication network.

27. The method according claim 2, wherein located between a customer telephony equipment and the time-division multiplex oriented communication network a broadband subscriber line via which primary multiplex traffic is carried.

28. (Canceled)

29. (Canceled)
